(19) United States
(12) Patent Application Publication
(10) Pub. No.: US 2018/0157846 A1
(43) Pub. Date: Jun. 7, 2018

(54) Information processing method, electronic device and computer storage medium

(71) Applicant: Xi'an Zhongxing New Software Co. Ltd., Xi'an (CN)

(72) Inventors: Fengpeng Liu, Xi'an (CN); Dongmei Liu, Xi'an (CN)

(21) Appl. No.: 15/575,227

(22) PCT Filed: Jun. 17, 2015
(86) PCT No.: PCT/CN2015/081684

§ 371 Date: Nov. 17, 2017

(30) Foreign Application Priority Data
May 20, 2015 (CN) 201510260039.1

(51) Int. Cl. G06F 21/60

(52) U.S. Cl. CPC G06F 21/60

(57) ABSTRACT

Embodiments of the present disclosure provide an information processing method, an electronic device and a computer storage medium, the electronic device obtains, by the sensor unit, at least one trigger operation; detects whether the at least one trigger operation meets a preset encryption condition to acquire a detection result; determines target file data according to preset rules when the detection result is the at least one trigger operation meets the preset encryption conditions; and encrypts the target file data.

### TECHNICAL FIELD

The present disclosure relates to the field of communication, and in particular relates to an information processing method, an electronic device and a computer storage medium.

### BACKGROUND

Currently, the electronic device may store therein various format of files, such as video, image, audio and other multimedia files data, particularly files involving privacy of the user or files containing important data that stores in the laptop computer. In order to realize the security management of files, traditional method of file encryption is mainly by software solution, the only method of file encryption relying on hardware is the fingerprinting recognition. The method of fingerprinting recognition collects fingerprint by fingerprint recognition module, makes determination by software algorithm and further implements the key management.

However, problems of the method of fingerprinting recognition combining hardware and software are complicated solution, high cost and difficulty of realization. And the software algorithm that corresponds to the fingerprinting recognition is immature and low security.

### SUMMARY

Embodiments of the present disclosure provide an information processing method, an electronic device and a computer storage medium, so as to achieve file encryption by a combination of hardware and software.

The technical solution for embodiments of the present disclosure is achieved as follows.

According to embodiments of the present disclosure, the present disclosure provides a method for information processing, applied to electronic device, wherein the electronic device includes a sensor unit, the method comprising: obtaining, by the sensor unit, at least one trigger operation; detecting whether the at least one trigger operation meets a preset encryption condition to acquire a detection result; determining target file data according to preset rules when the detection result is the at least one trigger operation meets the preset encryption conditions; and encrypting the target file data.

In one embodiment, the detecting whether the at least one trigger operation meets a preset encryption condition comprises: detecting whether there is a encryption operation in the encryption operation database matching each of the at least one trigger operation.

In one embodiment, the at least one trigger operation comprises at least two trigger operations; and the detecting whether there is an encryption operation in the encryption operation database matching each of the at least one trigger operation comprises: detecting whether there is an encryption operation in the encryption operation database matching each of the at least two trigger operations in a preset period of time.

In one embodiment, the determining target file data according to preset rules comprises: determining currently-open file data as the target file data; or determining all multimedia file data stored in the electronic device as the target file data; or determining current file data obtained by the electronic device as the target file data.

In one embodiment, the encrypting the target file data comprises: encrypting the target file data with a encryption key matching with each of the at least one trigger operation.

In one embodiment, the encrypting the target file data comprises: re-encoding the target file data to make the target file data not be opened normally.

Embodiments of the present disclosure also provide a computer storage medium stores computer-executable instructions, wherein the computer-executable instructions are used for executing the information processing method of embodiments of the present disclosure.

Embodiments of the present disclosure also provide an electronic device, comprising: a sensor unit, a detection unit, a determination unit and an encryption unit, wherein the sensor unit is configured to obtain at least one trigger operation; the detection unit is configured to detect whether the at least one trigger operation meets a preset encryption condition to acquire a detection result; the determination unit is configured to determine target file data according to preset rules when the detection result is the at least one trigger operation meets the preset encryption conditions; and the encryption unit is configured to encrypt the target file data.

In one embodiment, the detection unit is configured to detect whether there is a encryption operation in the encryption operation database matching each of the at least one trigger operation.

In one embodiment, the at least one trigger operation comprises at least two trigger operation; and the detection unit is configured to detect whether there is a encryption operation in the encryption operation database matching each of the at least two trigger operations in a preset period of time.

In one embodiment, the determination unit is configured to determine currently-open file data as the target file data; or determine all multimedia file data stored in the electronic device as the target file data; or determine current file data obtained by the electronic device as the target file data.

In one embodiment, the encryption processing unit is configured to encrypt the target file data with a encryption key matching with each of the at least one trigger operation.

In one embodiment, the encryption processing unit is configured to re-encode the target file data to make the target file data not be opened normally.

The embodiments of the present disclosure provide the information processing method, electronic device and computer storage medium, the electronic device obtains, by the sensor unit, at least one trigger operation; detects whether the at least one trigger operation meets a preset encryption condition to acquire a detection result; determines target file data according to preset rules when the detection result is the at least one trigger operation meets the preset encryption conditions; and encrypts the target file data. In this way, file encryption can be achieved by the method of a combination of hardware and software, the method is easy to implement and provides higher reliability and do not require extra cost.

### BRIEF DESCRIPTION OF DRAWINGS

FIG. 1 is flow chart 1 illustrating a method for information processing according to an embodiment of the present disclosure.

FIG. 2 is schematic diagram 1 illustrating hardware components of the electronic device according to an embodiment of the present disclosure.

FIG. 3 is flow chart 2 illustrating a method for information processing according to an embodiment of the present disclosure.

FIG. 4 is schematic diagram 2 illustrating hardware components of the electronic device according to an embodiment of the present disclosure.

FIG. 5 is a structural diagram illustrating the electronic device according to an embodiment of the present disclosure.

### DETAILED DESCRIPTION

In embodiments of the present disclosure, the electronic device obtains, by the sensor unit, at least one trigger operation; detects whether the at least one trigger operation meets a preset encryption condition to acquire a detection result; determines target file data according to preset rules when the detection result is the at least one trigger operation meets the preset encryption conditions; and encrypts the target file data.

The embodiments of the present disclosure are further described by means of specific embodiments with reference to the accompanying drawings.

### Embodiment 1

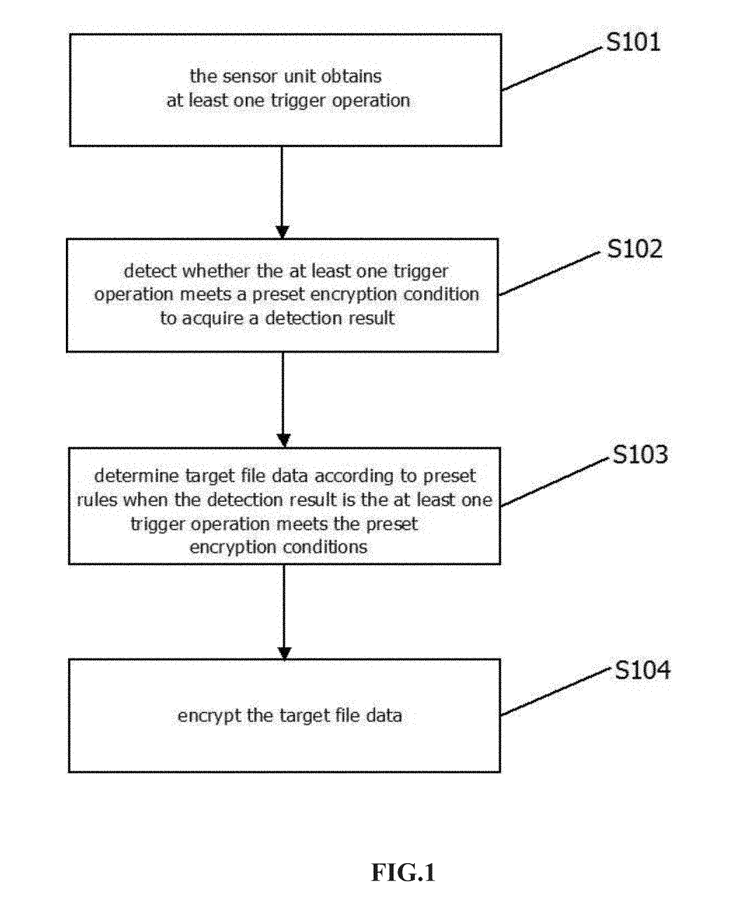

FIG. 1 is a flow chart illustrating a method for information processing according to an embodiment of the present disclosure, and the method may apply to an electronic device, the electronic device includes a sensor unit. As shown in FIG. 1, the method includes the following steps.

In step S101, the sensor unit obtains at least one trigger operation.

The electronic device can be a cell phone, a PC (Personal Computer), a tablet computer, a PDA (personal digital assistant) and so on. The sensor unit may include a combination of different types of sensor within the electronic device, where the different types of sensor may include a temperature sensor, a light sensor, a pressure sensor, an acceleration sensor and so on.

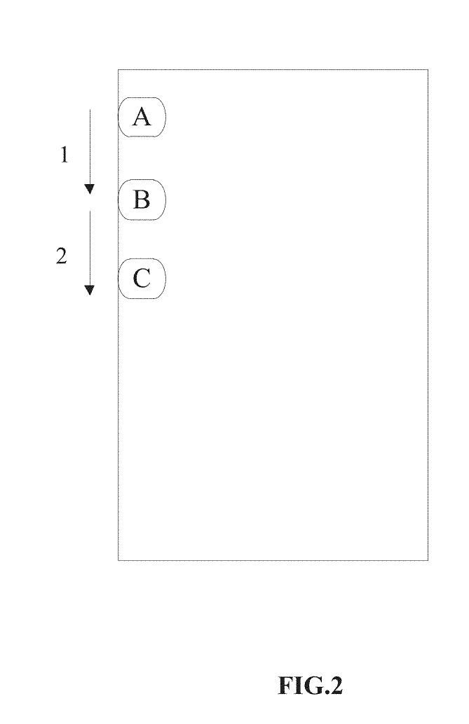

In one embodiment, three temperature sensors named A, B, C are located at upper left side edge of the electronic device, and may acquire the temperature rapidly and accurately. The detailed data, including variations in the temperature in continuous period of time, may be acquired by the temperature sensors if the user fingers the temperature sensor. Particularly, as shown in FIG. 2, when the user needs to encrypt the file data and fingers the temperature sensors A, B, C in turn from top to bottom, data information including “this implement”, “specific time”, “specific speed” and so on will be recorded by the three temperature sensors rapidly and accurately. In this way, the order of “1” “2” sorted as shown in FIG. 2 is used as a combination of action, and also as at least one trigger operation obtained by the sensor unit according to embodiment 1 of the present disclosure.

In step S102, the electronic device may detect whether the at least one trigger operation meets a preset encryption condition to acquire a detection result.

Particularly, the electronic device detects whether the at least one trigger operation meets a preset encryption condition to acquire a detection result by detecting whether there is a encryption operation in the encryption operation database matching each of the at least one trigger operation. Here, the preset encryption condition will be predetermined in the electronic device and stored in the encryption operation database by user; where the preset encryption condition can be set based on the specific composition of the sensor unit within the electronic device.

In step S103, the electronic device determines target file data according to preset rules when the detection result is the at least one trigger operation meets the preset encryption conditions.

Particularly, the step that the electronic device determines target file data according to preset rules comprises: the electronic device determines currently-open file data as the target file data; or determines all multimedia file data stored in the electronic device as the target file data; or determines current file data obtained by the electronic device as the target file data. For example, the target file data may be video, image, audio and other multimedia files data, in particular files involving privacy of the user or files containing important data that stores in the laptop computer.

In one embodiment, the electronic device determines the photos that obtained by the photograph operation as the target file data when the user needs to encrypts the photos ha obtained by the photograph operation and the detection result is the at least one trigger operation meets the preset encryption conditions.

In step S104, the electronic device encrypts the target file data.

The electronic device may use different ways to encrypt the target file data. Particularly, the electronic device may encrypt the target file data according to a encryption key matching with each of the at least one trigger operation. In addition, the electronic device may also re-encode the target file data to make the target file data not be opened normally.

In one embodiment, as shown in FIG. 2, based on the correspondence between the at least one trigger operation and the encryption key, the electronic device sets the number “1 2” or the English letter “one two” as the code corresponding to the at least one trigger operation “1” “2”.

In this way, according to the information processing method of the embodiments of the present disclosure, the electronic device obtains, by the sensor unit, at least one trigger operation; when the detection result is the at least one trigger operation meets the preset encryption conditions, further determines target file data according to preset rules and encrypts the target file data. In this way, file encryption can be achieved by the method of combination of hardware and software, and the method is easy to implement and provides higher reliability and do not require extra cost.

Embodiments of the present disclosure also provide a computer storage medium storing computer-executable instructions, where the computer-executable instructions are used for executing the information processing method of embodiment I of the present disclosure.

### Embodiment 2

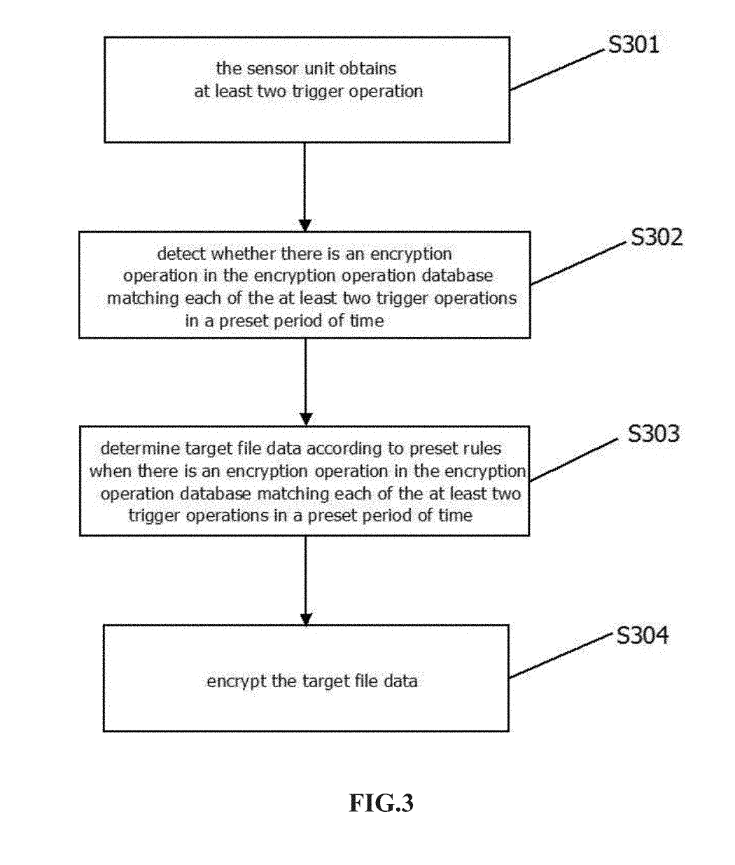

FIG. 3 is a flow chart illustrating a method for information processing according to an embodiment of the present disclosure, and the method may apply to an electronic device, the electronic device includes a sensor unit. As shown in FIG. 3, the method includes the following steps.

In step S301, the sensor unit obtains at least one trigger operation.

Unwanted encryption process may be caused and the encryption process may be performed too often because of user's incorrect manipulation when the electronic device only sets an encryption process corresponding to one trigger operation. To solve this problem, the at least one trigger operation according to embodiment 1 may be defined to at least two trigger operation, that is, the electronic device obtains at least two trigger operations by the sensor unit.

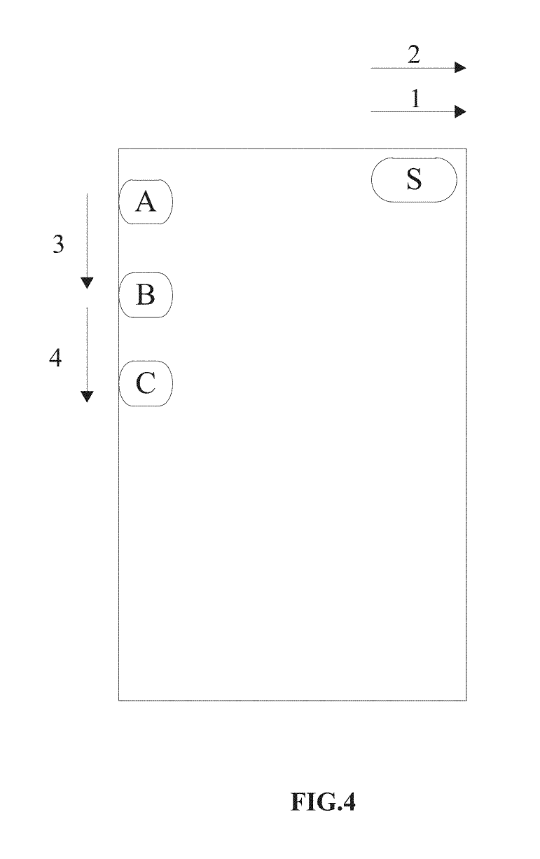

In one embodiment, three temperature sensors named A, B, C are located at upper left side edge of the electronic device, and may acquire the temperature rapidly and accurately. Particularly, as shown in FIG. 4, when the user needs to encrypt the file data and fingers the temperature sensors A, B, C in turn from top to bottom., data information including “this implement”, “specific time”, “specific speed” and so on will be recorded by the three temperature sensors rapidly and accurately. Meanwhile, a light sensor named S is located at upper right corner of the electronic device, and may acquire the particular intensity values of the light rapidly and accurately. The detailed data, including variations in the intensity of the light in continuous period of time, may be acquired by the light sensor if the light sensor is covered and light is reduced. Particularly, as shown in FIG. 4, when the user fingers the light sensor S and “unfold-shield-unfold” twice consecutively from left to right, data information including “this implement”, “specific time”, “specific speed” and so on will be recorded by the light sensor S rapidly and accurately. In this way, the order of “1” “2” “3” “4” sorted as shown in FIG. 4 is used as a combination of action, and also as at least two trigger operation obtained by the sensor unit according to embodiment 2 of the present disclosure.

In step S302, the electronic device may detect whether there is an encryption operation in the encryption operation database matching each of the at least two trigger operations in a preset period of time.

Where the preset encryption condition can be set based on the specific composition of the sensor unit within the electronic device.

Particularly, the electronic device detects whether there is an encryption operation in the encryption operation database matching each of the at least two trigger operations in a preset period of time; where, the preset period of time may be set based on the period of time that user implements the at least two trigger operations and the detection rate of the electronic device. in practical use, as the detection rate that the electronic device detects whether there is an encryption operation in the encryption operation database matching each of the at least two trigger operations is very quickly, the consumption time for detection may be negligible and the preset period of time may be set as a period of time for implementing the at least two trigger operations by the normal user.

In one embodiment, as shown in FIG. 4, the encryption operations “1” “2” “3” “4” as shown in figure may be predetermined and stored in the encryption operation database by user. In this way, the electronic device determines that there is an encryption operation in the encryption operation database matching each of the at least two trigger operations in a preset period of time when the electronic device obtains at least two trigger operations such as “1” “2” “3” “4” by the sensor unit.

In step S303, the electronic device determines target file data according to preset rules when there is an encryption operation in the encryption operation database matching each of the at least two trigger operations in a preset period of time.

Particularly, the step that the electronic device determines target file data according to preset rules comprises: the electronic device determines currently-open file data as the target file data; or determines all multimedia file data stored in the electronic device as the target file data; or determines current file data obtained by the electronic device as the target file data. For example, the target file data may be video, image, audio and other multimedia files data, in particular files involving privacy of the user or files containing important data that stores in the laptop computer.

In one embodiment, the electronic device determines the photos that obtained by the photograph operation as the target file data when the user needs to encrypt the photos that obtained by the photograph operation and the detection result is the at least one trigger operation meets the preset encryption conditions.

In step S304, the electronic device encrypts the target file data.

The electronic device may use different ways to encrypt the target file data. Particularly, the electronic device may encrypt the target file data according to a encryption key matching with each of the at least one trigger operation. In addition, the electronic device may also re-encode the target file data to make the target file data not be opened normally.

The electronic device may use different is to encrypt the target file data. Particularly, the electronic device may encrypt the target file data according to a encryption key matching with each of the at least one trigger operation. In addition, the electronic device may also re-encode the target file data to make the target file data not be opened normally.

In one embodiment, as shown in FIG. 4, based on the correspondence between the at least two trigger operations and the encryption key, the electronic device sets the number “1 2 3 4” or the English letter “one two three four” as the code corresponding to the at least two trigger operation “1” “2” “3” “4”.

In this way, according to the information processing method of the embodiments of the present disclosure, the electronic device obtains, by the sensor unit, at least two trigger operations; when the detection result is the at least two trigger operations meets the preset encryption conditions, further determines target file data according to preset rules and encrypts the target file data. In this way, file encryption can be achieved by the method of combination of hardware and software, and the method is easy to implement and provides higher reliability and do not require extra cost.

Embodiments of the present disclosure also provide a computer storage medium storing computer-executable instructions, where the computer-executable instructions are used for executing the information processing method of embodiment 1 of the present disclosure.

### Embodiment 3

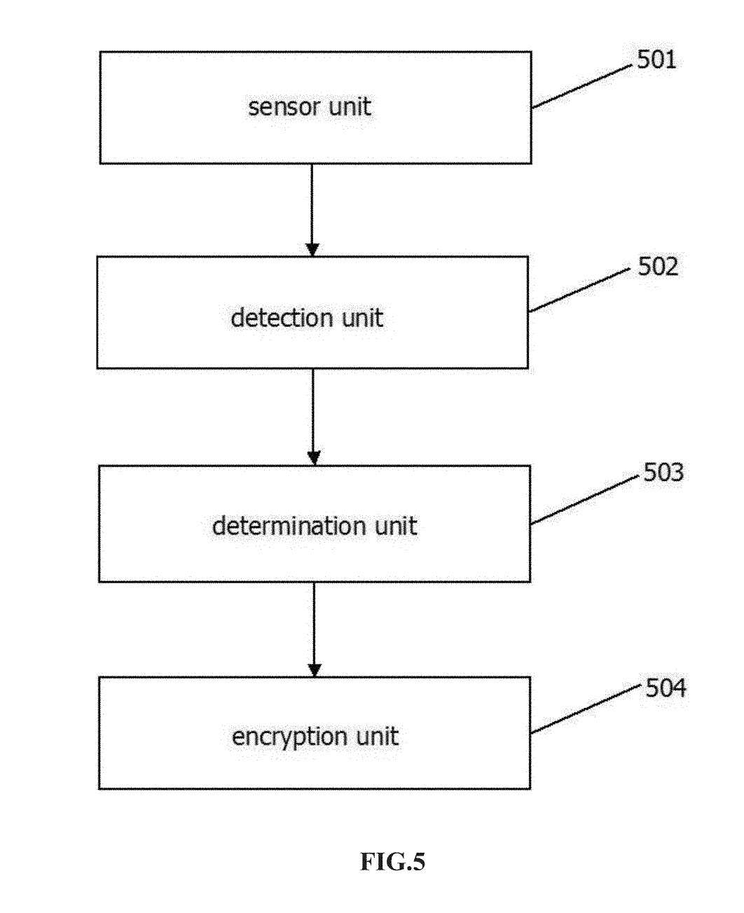

FIG. 5 is a structural diagram illustrating the electronic device according to an embodiment of the present disclosure as shown in FIG. 5, the electronic device comprises: a sensor unit 501, a detection unit 502, a determination unit 503 and an encryption unit 504.

The sensor unit 501 is configured to obtain at least one trigger operation.

The detection unit 502 is configured to detect whether the at least one trigger operation meets a preset encryption condition to acquire a detection result.

Particularly, the detection unit 502 detects whether there is a encryption operation in the encryption operation database matching each of the at least one trigger operation.

In one embodiment, when the at least one trigger operation comprises at least two trigger operations; the detection unit 502 is configured to detect whether there is a encryption operation in the encryption operation database matching each of the at least two trigger operations in a preset period of time.

The determination unit 503 is configured to determine target file data according to preset rules when the detection result is the at least one trigger operation meets the preset encryption conditions.

Particularly, the determination unit 503 is configured to determine currently-open file data as the target file data; or determine all multimedia file data stored in the electronic device as the target file data; or determine current file data obtained by the electronic device as the target file data.

The encryption unit 504 is configured to encrypt the target file data.

Particularly, in one embodiment, the encryption unit 504 is configured to encrypt the target file data with a encryption key matching with each of the at least one trigger operation. in another embodiment, the encryption unit 504 is configured to re-encode the target file data to make the target file data not be opened normally.

According to embodiments of the present disclosure, the sensor unit 501 may include a combination of different types of sensors within the electronic device, where the different types of sensors may include a temperature sensor, a light sensor, a pressure sensor, an acceleration sensor and so on. The detection unit 502, the determination unit 503 and the encryption unit 504 in the electronic device may be achieved by processor in electronic device or particular logic circuit, for example, when in practical use, may be achieved by CPU (Central Processing Unit), MPU (Micro Processor Unit), DSP (Digital Signal Processor) or FPGA (Field Programmable Gate Array) within electronic device.

Those skilled in the art should understand that the embodiments provided by the present disclosure may be a method, a system or a computer program product. Accordingly, the present disclosure may be implemented by foftware, hardware and a combinaton of hardware and software. Furthermore, the present disclosure may take the form of a computer program product to be implemented in one or more computer storage medium (including but not limited to disk storage and optical memory) storing computer usable program code.

The present disclosure is described with reference to flowcharts and/or block diagrams of the method, the equipment (system) and the computer program product of the embodiment of the present disclosure. It should be understood that each flow and/or block in the flowcharts and/or the block diagrams and the combination of the flows and/or blocks in the flowcharts and/or the block diagrams may be implemented by the computer program instructions. These computer program instructions may he provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further he loaded onto the computer or the other programmable data processing equipment, so that a series of operating acts are executed on the computer or the other programmable data processing equipment to generate processing implemented by the computer, and acts for realizing the function specified in one flow or many flows in the flowcharts and/or one block or many blocks in the block diagrams are provided by the instructions executed on the computer or the other programmable data processing equipment.

The above are merely embodiments of the present disclosure and are not intended to limit the scope of protection of the present disclosure. it will be apparent to those skilled in the art that various changes, substitutions may be made without departing from the scope and spirit of the disclosure.

### INDUSTRIAL APPLICABILITY

According to the information processing method described in embodiments of the present disclosure, the electronic device obtains, by the sensor unit, at east one trigger operation; detects whether the at least one trigger operation meets a preset encryption condition to acquire a detection result; determines target file data according to preset rules when the detection result is the at least one trigger operation meets the preset encryption conditions; and encrypts the target file data. In this way, file encryption can be achieved by the method of a combination of hardware and software, the method is easy to implement and provides higher reliability and do not require extra cost.

1. A method for information processing, applied to electronic device, wherein the electronic device includes a sensor unit, the method comprising:
obtaining, by the sensor unit, at least one trigger operation;
detecting whether the at least one trigger operation meets a preset encryption condition to acquire a detection result;
determining target file data according to preset rules when the detection result is the at least one trigger operation meets the preset encryption conditions; and
encrypting the target file data.

2. The method according to claim 1, wherein the detecting whether the at least one trigger operation meets a preset encryption condition comprises:
detecting whether there is an encryption operation in the encryption operation database matching each of the at least one trigger operation.

3. The method according to claim 2, wherein the at least one trigger operation comprises at least two trigger operations;
the detecting whether there is an encryption operation in the encryption operation database matching each of the at least one trigger operation comprises:
detecting whether there is an encryption operation in the encryption operation database matching each of the at least two trigger operations in a preset period of time.

4. The method according to claim 1, wherein the determining target file data according to preset rules comprises:
determining currently-open file data as the target file data; or
determining all multimedia file data stored in the electronic device as the target file data; or
determining current file data obtained by the electronic device as the target file data.

5. The method according to claim 1, wherein the encrypting the target file data comprises:
encrypting the target file data with a encryption key matching with each of the at least one trigger operation.

6. The method according to claim 1, wherein the encrypting the target file data comprises:
re-encoding the target file data to make the target file data not be opened normally.

7. An electronic device, comprising: a sensor unit, a detection unit, a determination unit and an encryption unit, wherein
the sensor unit is configured to obtain at least one trigger operation;
the detection unit is configured to detect whether the at least one trigger operation meets a preset encryption condition to acquire a detection result;
the determination unit is configured to determine target file data according to preset rules when the detection result is the at least one trigger operation meets the preset encryption conditions; and
the encryption unit is configured to encrypt the target file data.

8. The electronic device according to claim 7, wherein
the detection unit s configured to detect whether there is a encryption operation in the encryption operation database matching each of the at least one trigger operation.

9. The electronic device according to claim 8, wherein the at least one trigger operation comprises at least two trigger operation;
the detection unit is configured to detect whether there is a encryption operation in the encryption operation database matching each of the at least two trigger operations in a preset period of time.

10. The electronic device according to claim 7, wherein
the determination unit is configured to determine currently-open file data as the target file data; or determine all multimedia file data stored in the electronic device as the target file data; or determine current file data obtained by the electronic device as the target file data.

11. The electronic device according to claim 7, wherein
the encryption processing unit is configured to encrypt the target file data with a encryption key matching with each of the at least one trigger operation.

12. The electronic device according to claim 7, wherein
the encryption processing unit is configured to re-encode the target file data to make the target file data not be opened normally.

13. A non-transitory computer storage medium storing computer executable instructions for performing the method for information processing according to claim 1.

14. The method according to claim 2, wherein the determining target file data according to preset rules comprises:
determining currently-open file data as the target file data; or
determining all multimedia file data stored in the electronic device as the target file data; or
determining current file data obtained by the electronic device as the target file data.

15. The method according to claim 3, herein the determining target file data according to preset rules comprises:
determining currently-open file data as the target file data; or
determining all multimedia file data stored in the electronic device as the target file data; or
determining current file data obtained by the electronic device as the target file data.

16. The method according to claim 2, wherein the encrypting the target file data comprises:
encrypting the target file data with a encryption key matching with each of the at least one trigger operation.

17. The method according to claim 3, wherein the encrypting the target file data comprises:
encrypting the target file data with a encryption key matching with each of the at least one trigger operation.

18. The method according to claim 2, wherein the encrypting the target file data comprises:
re-encoding the target file data to make the target file data not be opened normally.

19. The method according to claim 3, wherein the encrypting the target file data comprises:
re-encoding the target file data to make the target file data not be opened normally.
